(19) United States
(12) Patent Application Publication
(10) Pub. No.: US 2024/0010514 A1
(43) Pub. Date: Jan. 11, 2024

(54) Nanomaterial Composites Useful for the Extraction and Recovery of Lithium from Aqueous Solutions

(71) Applicant: Litus Inc., Alberta (CA)

(72) Inventors: Gerardo Vitale ROJAS, Alberta (CA); Ghada NAFIE, Alberta (CA); Pedro Almao PEREIRA, Alberta (CA)

(21) Appl. No.: 18/018,666

(22) PCT Filed: Aug. 25, 2021
(86) PCT No.: PCT/CA2021/051179

§ 371 Date: Jan. 30, 2023

Related U.S. Application Data
(60) Provisional application No. 63/071,790, filed on Aug. 28, 2020.

(51) Int. Cl. C01G 23/00; C01B 33/36; C01G 25/00; B01D 15/08; B01J 39/02; B01J 39/10; B01J 39/14; B01J 49/53; B01J 49/06

(52) U.S. Cl. CPC C01G 23/005; C01B 33/36; C01G 25/006; B01D 15/08; B01J 39/02; B01J 39/10; B01J 39/14; B01J 49/53; B01J 49/06; C01P 2002/60; C01P 2002/72; C01P 2004/03; C01P 2002/82; C01P 2002/88; C01P 2006/12; C01P 2006/14; C01P 2006/16

(57) ABSTRACT

The present disclosure relates to nanomaterial composites capable of selectively extracting lithium from a lithium-containing liquid resource when the nanomaterial composite is activated, a method of preparing the nanomaterial composites, and the use of the nanomaterial composites for the extraction and recovery of lithium.

### CROSS-REFERENCE TO RELATED APPLICATION

This application claims the benefit of U.S. Provisional Patent Application Ser. No. 63/071,790 filed on Aug. 28, 2020. The content of the aforementioned application is incorporated by reference herein.

### FIELD

The present disclosure generally relates to: a nanomaterial composite allowing for the selective extraction of lithium from a liquid resource, the nanomaterial composite having size opening restrictions (cavities/channels) and nano-crystalline domain sizes (<100 nm) to allow only for the entrance and exit of lithium ions contained in the liquid resource while substantially excluding all other ions present in the liquid resource; a method of producing the nanomaterial composite; and, a method of using the nanomaterial composite for extracting lithium from the liquid resource and the subsequent recovery of the extracted lithium upon treatment with an acid solution.

### BACKGROUND

The demand for lithium has been increasing due to its use in a variety of applications, such as lithium-ion batteries (LiBs) including Li₂CO₃, LiOH, Li metal, LiPF₆, LiCl, Li alloys, LiCoO₂ and other Li electrode compositions. Specialized glasses and ceramics also account for important demands of lithium as LiAlSi₂O₆ (spodumene) and Li₂CO₃.

Conventional methods for lithium extraction are based on the modifications of natural minerals rich in lithium, like spodumene and pegmatite, by thermal and acid treatments. However, these treatments are too expensive, energy intensive and produce large amounts of waste and non-desired products since the mineral must be grinded, calcined at high temperature (˜1000° C.) and treated with sulfuric acid (at 250° C.) in order to recover the lithium as Li₂SO₄. Another conventional method to recover lithium is by the natural evaporation of brines in large ponds, usually called “salares”. In this particular method, there is an important dependence on the weather which affects the rate of evaporation and thus the concentration of lithium in the brine. Long residence times of between 1 to 3 years are required to obtain suitable brine with high lithium content (about 6%) thereby affecting the environment since important amounts of terrain must be used to produce the salar ponds. The estimated recoverable amount of lithium by the previously described conventional methods has been found to be about 14,000,000 tons.

A larger source of lithium can be found in sea water with an estimated recoverable amount of 230,000,000,000 tons. However, the concentration of lithium in sea water is very low (0.1 to 0.25 ppm), and thus not suitable for recovery using such conventional methods above.

One alternative method for extracting lithium from other aqueous sources (like brines), where the concentration of lithium may be between 30 ppm and 3,000 ppm, is through the use of an ion-exchange material. However, besides lithium ions, brines also contain other cations like Na⁺, K⁺, Rb⁺, Cs⁺, Mg²⁺, Ca²⁺, Sr²⁺, Ba²⁺ each of which may be present in higher concentrations and with a higher charge/size ratio (for e.g. Mg²⁺ and Ca²⁺) making the separation of lithium using conventional ion-exchange materials (for e.g. zeolites) difficult since they are not selective for lithium and will uptake all other cations.

Thus, in order for an ion-exchange material to be suitable for lithium extraction from brines, the material must be capable of selectively extracting lithium ions from all of the other cations present in the brine. In addition to this “size confinement” (i.e., size exclusion of other cations which are larger than lithium ions), protons (H⁺) must also be considered since they have the charge and size required to displace or replace lithium from the ion-exchange material during regeneration. Accordingly, suitable ion-exchange materials must be capable of allowing for the entrance and exit of: (i) only lithium ions when contacted with brine to selectively extract lithium; and, (ii) proton ions when contacted with an acid during regeneration subsequently leading to the recovery of lithium as a salt of the acid.

One of the most well-known conventional adsorbents used for the extraction/recovery of lithium is lithium aluminum layered double hydroxide chloride (LiCl—2Al(OH)₃). This adsorbent material can be prepared and composited differently to allow it to have certain properties that are different from other LiCl—2Al(OH)₃ materials. Thus, it is possible to produce LiCl—2Al(OH)₃ composites having similar crystalline structures, but having different properties and therefore they will not be the same composite. This also applies to lithium titanates and lithium manganates and their composites. Lithium titanates are a family of materials containing lithium, titanium and oxygen atoms that do not exhibit a single crystalline material like LiCl—2Al(OH)₃. Instead, there are several lithium titanates having different compositions and different crystalline structures. It is also possible for some lithium titanates to have the same composition but different crystalline structure. Lithium manganates have also been found to not have one unique crystalline structure but several with variations in their composition as well.

Examples describing the above adsorbents for lithium extraction/recovery from brines in ion-exchange processes can be found in “Lithium recovery from aqueous resources and batteries—a brief review,” Johnson Matthey Technology Review, 2018, 62(2), 161-176 and G. Liu, Z. Zhao, A. Ghahreman and “Novel approaches for lithium extraction from salt-lake brines: a review”, Hydrometallurgy, 2019, 187, 81-100. The three more promising adsorbents include the spinel lithium manganese oxide (Li—Mn—O) family, also known as lithium manganates; the spinel lithium titanium oxide (Li—Ti—O) family, also known as lithium titanates; and the lithium aluminum layered double hydroxide chloride (LiCl—2Al(OH)₃) or LDH. The most common issue found with Li—Mn—O is a decrease in ion-exchange capacity since the Mn²⁺ ion dissolutes and leaches when the material is treated with an acid during the regeneration of the material and recovery of lithium, and thus has very poor cycling stability (short-lived sorbent). While the Li—Ti—O family of sorbents appeared to be attractive for selectively extracting lithium, only between 40% to 50% of the theoretical value of 142.9 mg_{Li}/g_{solid} can be processed which may be due to the agglomeration of particles caused by the high-temperature synthesis of these materials thereby producing large crystals and very heterogeneous morphologies that affect the diffusion and recovery of lithium. While Ti⁴⁺ appeared to be stable in the Li—Ti—O structure, there seems to be issues with this structure when the material is exposed to acid solutions for the purpose of regeneration. LDH can be synthesized by intercalating LiCl into gibbsite (α-Al(OH)₃) to produce LiCl—2Al(OH)₃ and appeared to be an attractive candidate for applications in large industrial plants because of its low cost to manufacture, environmental-friendliness and easy regeneration. Problems associated with the use of LDH are related to the ability of controlling the maximum incorporation of lithium within the structure, and thus have unreliable cycling efficiency.

Further examples describing material useful in extracting lithium can be found in U.S. Pat. Nos. 5,389,349, 6,280,631, 10,266,915, 10,328,424, US20190275473, WO2015162272A1 and French Patent No. FR3015456. Other references, such as U.S. Pat. Nos. 6,890,510 and 6,475,673 describe the production of lithium titanates by very complex and cumbersome processes which make them non-suitable for homogeneous large production scale. For instance, U.S. Pat. No. 6,890,510 targets the production of a lithium titanate having the composition Li₄Ti₅O₁₂ (at least 98% by weight). The calcined material must be dispersed in order to be able to separate the obtained crystallites which is an additional step in the production process. U.S. Pat. No. 6,475,673 describes the production of mixtures of titanates for the production of negative electrodes for lithium ion batteries, such as TiO₂ and Li₂TiO₃ or TiO₂+Li₂TiO₃+Li₄Ti₅O₁₂. However, both must be sintered at a temperature range of 800° C. to 950° C.

More recently, U.S. Pat. No. 10,322,950 describes several adsorbents identified by theoretical calculations for lithium extraction and recovery. In particular, high-throughput density functional theory and specific ion interaction theory was used to predict lithium metal oxide compounds suitable for lithium extraction. From the Open Quantum Materials Database (OQMD) of ˜400,000 compounds, 77 lithium metal oxide compounds were first selected under the assumption they were stable or nearly stable in their “lithiated” states. Using the calculations described above, fourteen compounds from these 77 candidates were further assumed to be useful for lithium extraction from brines including: Li₄TiO₄, Li₇Ti₁₁O₂₄, LiTiO₂, LiAlO₂, LiCuO₂, Li₂SnO₃, Li₂MnO₃, Li₂FeO₃, Li₃VO₄, Li₂Si₃O₇, LiFePO₄, Li₂CuP₂O₇, Li₄Ge₅O₁₂, Li₄GeO₄ and Li₂MnO₃. This reference does not describe or exemplify the preparation of these materials which one skilled in the art knows to be extremely important since one crystalline material may be prepared several different ways thereby producing different sizes and morphologies affecting their performance. Furthermore, there are no examples where these proposed materials were used for lithium extraction, only descriptions of the calculations carried out where the crystal structure of the solids and their intake of Li/H was assumed, as well conditions typically present in brines. The teachings described in this reference were also published in “Computational Discovery of Li—M—O Ion Exchange Materials for Lithium Extraction from Brines”; Chem. Mater. 2018, 30, 6961-6968.

Finally, U.S. Pat. No. 10,648,090 describes an integrated system for lithium extraction from brines and its conversion to valuable lithium products. All working examples teach the use of the lithium sorbent Li₄Mn₅O₁₂ coated with ZrO₂ is necessary to prevent or diminish the dissolution of manganese during the activation of the material or the recovery of the lithium after treating with acids which is a well-known drawback for lithium manganate materials. The integrated process also uses cation and anion conducting membranes comprised of functionalized polymer structures with thicknesses from about 1 μm to about 10 mm as well as one or more electrochemically reducing electrodes comprised of titanium, niobium, zirconium, tantalum, magnesium, titanium dioxide, oxides thereof, or combinations thereof.

In spite of the above, there is a continuing need for the development of new adsorbent materials which may be used in ion exchange processes for the selective extraction of lithium from multi complex brines and its subsequent recovery in high yields when the material is contacted with an acid.

### SUMMARY

The present disclosure provides a nanomaterial composite obtained by mixing in an aqueous medium at least one lithium source and at least one other source selected from a silicon source, an aluminum source, a titanium source, a zirconium source, a metal-phosphate source and a mixture thereof to form a suspension at an atomic molar ratio of lithium to other source of at least 2.0:1; subjecting the suspension to a hydrothermal treatment to form the nanomaterial composite; and optionally subjecting the nanomaterial composite to a thermal treatment wherein the nanomaterial composite has a domain size of less than about 100 nm.

Embodiments within the scope of the present disclosure thus include the preparation of slurries, for instance, adding the lithium source (for e.g. lithium hydroxide) to dispersions of other sources, such as nanocrystalline oxides like TiO₂, ZrO₂, etc. or amorphous nanomaterials like colloidal SiO₂ and mixtures thereof in an aqueous medium and subjecting the slurries to a hydrothermal treatment to produce the nanomaterial composites of the present disclosure. These produced nanomaterial composites can be further submitted to thermal treatments to control or enhance their stability and performance at temperatures ranging from about 100° C. to about 1050° C. and for periods of time from about 1 hour to about 84 hours.

The nanomaterial composites may be shaped and sized for use in fixed bed ion-exchange processes. For example, the nanomaterial composites may be placed within the column and then activated by contacting the composites with an acid solution to exchange the lithium ions within the composite with hydrogen ions. A liquid resource is then passed through the ion-exchange column to selectively extract lithium from the liquid resource to form a lithium-enriched nanomaterial composite (i.e. the hydrogen ions are exchanged with lithium ions). The lithium-enriched nanomaterial composite is then contacted with an acid solution to recover the lithium as a lithium salt.

### BRIEF DESCRIPTION OF THE DRAWINGS

FIG. 1 is a schematic illustration is one embodiment for lithium extraction/recovery using an ion-exchange method of the present disclosure;

FIG. 2 is a schematic diagram of how a lithium titanate nanomaterial composite according to the present disclosure can be prepared using a hydrothermal method;

FIG. 3 is an X-ray diffraction pattern of the obtained crystalline phase of the lithium titanate of EXAMPLE 1 according to the present disclosure;

FIG. 4 is a Scanning Electron Microscopy image of the obtained crystalline phase of the lithium titanate of EXAMPLE 1 according to the present disclosure;

FIG. 5 is an X-ray diffraction pattern of the obtained crystalline phase of the lithium titanate of EXAMPLE 2 according to the present disclosure;

FIG. 6 is a Scanning Electron Microscopy image of the obtained crystalline phase of the lithium titanate of EXAMPLE 2 according to the present disclosure;

FIG. 7 is an X-ray diffraction pattern of the obtained crystalline phase of the lithium titanate of EXAMPLE 3 according to the present disclosure;

FIG. 8 is a Scanning Electron Microscopy image of the obtained crystalline phase of the lithium titanate of EXAMPLE 3 according to the present disclosure;

FIG. 9 is an X-ray diffraction pattern of the obtained crystalline phase of the lithium silicate of EXAMPLE 4 according to the present disclosure;

FIG. 10 is a Scanning Electron Microscopy image of the obtained crystalline phase of the lithium silicate of EXAMPLE 4 according to the present disclosure;

FIG. 11 is an X-ray diffraction pattern of the obtained crystalline phase of the lithium silicate of EXAMPLE 5 according to the present disclosure;

FIG. 12 is a Scanning Electron Microscopy image of the obtained crystalline phase of the lithium silicate of EXAMPLE 5 according to the present disclosure;

FIG. 13 is an X-ray diffraction pattern of the obtained crystalline phase of the lithium zirconate of EXAMPLE 6 according to the present disclosure;

FIG. 14 is an X-ray diffraction pattern of the obtained crystalline phase of the aluminum-doped lithium silicate of EXAMPLE 7 according to the present disclosure;

FIG. 15 is an X-ray diffraction pattern of the obtained crystalline phase of the lithium aluminosilicate of EXAMPLE 8 according to the present disclosure;

FIG. 16 is an X-ray diffraction pattern of the obtained crystalline phase of the lithium titanate of EXAMPLE 11 according to the present disclosure;

FIG. 17 is an X-ray diffraction pattern of the obtained crystalline phase of the lithium titanate of EXAMPLE 11 after calcination at 550° C. according to the present disclosure;

FIG. 18 shows infrared spectra of the crystalline phase of the lithium titanate of EXAMPLE 11 calcined at 550 ° C. before and after the activation process according to the present disclosure;

FIG. 19 is an X-ray diffraction pattern of the obtained lithium nitrate salt of EXAMPLE 13 according to the present disclosure; and

FIG. 20 is a DSC-TGA thermogram of the obtained lithium nitrate salt of EXAMPLE 13 according to the present disclosure;

### DETAILED DESCRIPTION

The present disclosure generally relates to nanomaterial composites prepared for use in processes to selectively extract lithium from a liquid resource and subsequently recovering such lithium, and more particularly, to such nanomaterial composites in which the nanomaterial composites have the affinity to selectively extract lithium from the liquid resource and substantially exclude other ions present in the liquid resource. Applicant has surprisingly found that when the nanomaterial composites of the present disclosure are produced according to specific methods, the nanomaterial composites have: size opening restrictions within their structural mouths or window entrances that only allow lithium ions (and proton ions) to enter and exit the nanomaterial composites; and, small crystalline domain sizes in the nano range (<about 100 nm) allowing fast exchange.

Accordingly, the selected nanomaterial composites of the present disclosure are materials prepared with lithium in their structures and which allow the lithium ions to be ion-exchanged with hydrogen ions (i.e. lithium mobility) when contacted with an acid solution. In preferred embodiments, the nanomaterial composites may be produced by hydrothermal treatment methods. Alternative methods such as precipitation methods, solid state reactions methods and combinations of these with hydrothermal treatment are also within the scope of this disclosure. In these methods, the nanomaterial composites may be prepared by mixing soluble inorganic and organic components in such a way to produce a solution, a slurry or a gel which can be dried to recover solids or submitted to solid state reactions with temperatures ranging from about 100° C. up to about 1050° C. and times ranging from about 1 hour to about 84 hours. Alternatively, the previously prepared solution, slurry or gel can be directly submitted to a hydrothermal treatment at temperatures ranging from about 60° C. to about 250° C. and times ranging from about 1 hour to about 84 hours. The produced solid from the hydrothermal method can also be submitted to a thermal treatment at a temperature ranging from about 100° C. up to about 1050° C. and times ranging from about 1 hour to about 84 hours for the purpose of enhancing its structural stability and/or performance for the extraction/recovery of lithium.

Additionally, the present disclosure also provides a process to recover the extracted lithium from the nanomaterial composites by contacting the nanomaterial composite with an acid solution to form a lithium salt.

The following terms shall have the following meanings:

The term “comprising” and derivatives thereof are not intended to exclude the presence of any additional component, step or procedure, whether or not the same is disclosed herein. In order to avoid any doubt, all compositions claimed herein through use of the term “comprising” may include any additional additive or compound, unless stated to the contrary. In contrast, the term, “consisting essentially of” if appearing herein, excludes from the scope of any succeeding recitation any other component, step or procedure, except those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or to more than one (i.e. to at least one) of the grammatical objects of the article. The phrases “in one embodiment”, “according to one embodiment” and the like generally mean the particular feature, structure, or characteristic following the phrase is included in at least one embodiment of the present disclosure, and may be included in more than one embodiment of the present disclosure. Importantly, such phrases do not necessarily refer to the same aspect. If the specification states a component or feature “may”, “can”, “could”, or “might” be included or have a characteristic, that particular component or feature is not required to be included or have the characteristic.

The term “about” as used herein can allow for a degree of variability in a value or range, for example, it may be within 10%, within 5%, or within 1% of a stated value or of a stated limit of a range.

Values expressed in a range format should be interpreted in a flexible manner to include not only the numerical values explicitly recited as the limits of the range, but to also include all of the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

The term “substantially” refers to the complete or nearly complete extent or degree of an action, characteristic, property, state, structure, item, or result.

The term “substantially free” refers to a composition in which a particular compound or moiety is present in an amount that has no material effect on the composition. In some embodiments, “substantially free” may refer to a composition in which the particular compound or moiety is present in the composition in an amount of less than 2 wt. %, or less than 1 wt. %, or less than 0.5 wt. %, or less than 0.1 wt. %, or less than 0.05 wt. %, or even less than 0.01 wt. %, based on the total weight of the composition.

The term “liquid resource” refers to a natural brine, a dissolved salt flat, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, effluents from factories for producing cathodes or combinations thereof.

The term “selectively extracting” or “selective extraction” or “selectively extract” means removing lithium present in a liquid resource and leaving the remainder of the liquid resource unaffected (i.e. substantially all other ions in the liquid resource remain in the liquid resource).

The term “optional” or “optionally” means that the subsequently described event or circumstance may or may not occur, and that the description includes instances where said event or circumstance occurs and instances where it does not.

The nanomaterial composites according to the present disclosure may be obtained by mixing in an aqueous medium containing at least one lithium source at least one other source selected from a silicon source, an aluminum source, a titanium source, a zirconium source, a metal-phosphate source and a mixture thereof to form a suspension at an atomic molar ratio of lithium to other source (i.e. silicon or aluminum or titanium or zirconium or metal-phosphate) of at least 2.0:1; subjecting the suspension to a hydrothermal treatment at a temperature of between about 60° to about 250° C. for a period of time of between about 1 hour to about 84 hours to form the nanomaterial composite; and optionally subjecting the nanomaterial composite to a thermal treatment at a temperature of between about 100° C. and about 1050° C. for a period of time of between about 1 hour to about 84 hours wherein the nanomaterial composite has a domain size of less than about 100 nm. In some embodiments, the nanomaterial composite has a domain size of less than about 90 nm, or less than about 80 nm, or less than about 70 nm, or less than about 60 nm, or less than about 50 nm or even less than about 40 nm. In other embodiments, the nanomaterial composite has a domain size of between about 10 nm and about 90 nm, or between about 20 nm to about 60 nm, or between about 30 nm to about 50 nm.

To enhance stability and/or performance of the nanomaterial composites, other elements may be added to the composite during its preparation by including doping elements including, but not limited to the following: Al, Ti, Zr, Si, Fe, Mn, Zn, Co, Cu, P or mixtures thereof.

According to one embodiment, the at least one lithium source may be any compound comprising the element lithium and being capable of releasing this lithium element in an aqueous medium in a reactive form. The lithium source may be selected from lithium salts, preferably lithium chloride, lithium hydroxide, lithium nitrate, lithium sulfate, lithium carbonate and mixtures thereof.

According to another embodiment, the at least one other source that is mixed with the lithium source comprises titanium dioxide, zirconium oxide, silicon dioxide, aluminum nitrate, sodium silicate, aluminum hydroxide, sodium silicate, iron phosphate, zinc phosphate, zinc phosphate, manganese phosphate or magnesium phosphate.

Accordingly, the at least one lithium source and the at least one other source selected from a silicon source, an aluminum source, a titanium source, a zirconium source, a metal-phosphate source are mixed in the presence of water to obtain a suspension. In an alternative embodiment, the at least one other source may be treated with an acid or base in order to produce a suitable homogeneous precipitate or a smooth gel, either of which can be washed and dried to produce a precursor which is then mixed with the lithium source and water. The obtained suspension can then be subjected to a hydrothermal treatment to produce the nanomaterial composite. According to an embodiment, the obtained suspension is subjected to a hydrothermal treatment step at a temperature of between about 60° C. and about 250° C. for a period of time of between about 1 hour and about 84 hours. Preferably, the hydrothermal treatment is carried out at a temperature comprised between about 70° C. and about 200° C. or between about 70° C. and about 180° C. or between about and about 150° C., and for a period of time comprised of between about 5 hours and about 72 hours or between about 10 hours and about 36 hours.

The above hydrothermal treatment step is advantageously carried out according to techniques known to one skilled in the art. According to one embodiment, the hydrothermal treatment is carried out in a reactor, under autogenous pressure, and under an atmosphere saturated with water. Preferably, the hydrothermal treatment is carried out by introducing the lithium source, water and the other source (alone or mixed with an acid or base) simultaneously or individually into the reactor. In the case when the other source is introduced into the reactor in a mixture with an acid, the acid is advantageously selected from among nitric acid, hydrochloric acid, sulfuric acid and carboxylic acid. In the case when the other source is introduced into the reactor in a mixture with a base, the base is advantageously selected from lithium hydroxide, sodium hydroxide, potassium hydroxide and ammonia.

Preferably, the hydrothermal treatment is carried out in the presence of a humid atmosphere having a water content comprised between about 20% and 100% by weight, and preferably between about 50% and about 100% by weight, and preferably between 80% and 100% by weight.

Alternatively, the hydrothermal treatment may be carried out in a weathering oven in the presence of a humid air flow containing between about 20% and 100% by weight of water, or preferably between about 50% and 100% by weight of water or preferably between about 80% and 100% by weight of water, or in an oven operating under a humid air flow containing between about 20% and about 100% by weight of water, or preferably between about 50% and 100% by weight of water or preferably between about 80% and 100% by weight of water according to methods known to one skilled in the art.

The hydrothermal treatment step carried out under a controlled atmosphere allows for the possibility of obtaining a crystallized solid material having a domain size of less than 100 nm or less than 90 nm, or less than 80 nm or less than 70 nm, or less than 60 nm or less than 50 nm, or less than 40 nm having good strength and good mechanical resistance when the latter is placed in contact with a liquid resource, an acid solution or water. At the end of the hydrothermal treatment, the obtained nanomaterial composite is then advantageously recovered and may optionally be washed and dried. In another embodiment, the obtained nanomaterial composite may be subjected to a thermal treatment as described above.]

Although the selected nanomaterial composites may be produced by hydrothermal treatment and optionally a thermal treatment, alternative methods such as precipitation methods, solid state reactions methods and combinations of these with hydrothermal treatment are also within the scope of this disclosure. In these alternative methods, the nanomaterial composites may be prepared by mixing the above soluble inorganic components in such a way to produce a solution, a slurry or a gel which can be dried and the solid recovered or submitted to solid state reactions at temperatures ranging from about 100° C. up to about 1050° C. and times ranging from between about 1 hour to 84 hours. Alternatively, the previously prepared solution, slurry or gel can be subjected to a hydrothermal treatment at temperatures and times like those described above (i.e. from about 60° C. to about 250° C. and times ranging from about 1 hour to about 84 hours). The produced solid from the hydrothermal treatment can then be subjected to a thermal treatment at temperatures and times like those described above (i.e. temperatures ranging from about 100° C. up to about 1050° C. and times ranging from about 1 hour to about 84 hours) to enhance its structural stability and/or performance for the extraction/recovery of lithium from the liquid resource.

In another embodiment, a colloidal silica solution can be mixed with a lithium hydroxide solution (or other lithium salt) to precipitate a solid material, which may be washed, dried and then treated hydrothermally at a temperature of about 100° C. up to about 1050° C. and for a period of time from about 1 hour to about 84 hours in order to produce the nanomaterial composite of the present disclosure. In another embodiment, the colloidal silica solution can be mixed with lithium hydroxide (or other lithium salt) and placed as a smooth gel inside a reactor and hydrothermally treated at a temperature of about 60° C. up to about 250° C. and for a period of time from about 1 hour to about 84 hours in order to produce the nanomaterial composite of the present disclosure. The produced nanomaterial composite may be subjected to further thermal treatment at a temperature of from about 100° C. up to about 1050° C. and for a period of time from about 1 hour to about 84 hours to enhance its stability and performance.

It is also within the scope of this disclosure to add other elements to the composites to enhance their stability and/or performance, such as by the addition of elements like Al, Ti, Zr, Si, Fe, Mn, Zn, Co, Cu, P or mixtures thereof to the composites. These elements may further increase the performance of the nanomaterial composites via the addition of new lithium bearing sites that will enhance the ion-exchange with proton ions during an acid treatment step and thus, further enhance the recovery of lithium as a lithium salt.

For example, in one embodiment, the colloidal silica solution may be mixed with aluminum salts, like Al(NO₃)₃ or Al(OH)₃, together with lithium hydroxide (or other lithium salts) and placed as smooth doped-aluminum gel inside a reactor and treated under hydrothermal conditions at a temperature of from about 60° C. up to about 250° C. and for a period of time from about 1 hour to about 84 hours in order to produce a lithium Al-doped silicate which can be submitted to a further thermal treatment at a temperature of from about 100° C. up to about 1050° C. and for a period of time from about 1 hour to about 84 hours in order to produce a lithium Al-doped silicate nanomaterial composite having enhanced stability and performance.

In another embodiment, a lithium metal-phosphate nanomaterial composite can be prepared by addition of transition metals salts with valence 2+, like Fe²⁺, Zn²⁺, Co²⁺, Cu²⁺, Mn²⁺, Ni²⁺ and mixtures thereof to an acidic solution of phosphoric acid and then reacting the mixture with lithium hydroxide (or other lithium salt) to produce a precipitate or smooth gel that can be washed, dried, and hydrothermally treated to produce a lithium metal-phosphate nanomaterial composite of the present disclosure. In another embodiment, the aqueous mixture containing the above precipitate or smooth gel can be placed inside a reactor and treated under hydrothermal conditions from a temperature of about 65° C. up to about 200° C. and for a period of time from about 1 hour to about 84 hours in order to produce a lithium metal-phosphate which can then optionally be submitted to a further thermal treatment to control or enhance its stability and performance at a temperature of from about 100° C. up to about 1050° C. and for a period of time from about 1 hour to about 84 hours.

In one embodiment, the powdered nanomaterial composites may be composited with known material (for e.g. inorganic or organic binders, agglomerates, etc.) to shape and size the nanomaterial composites for placement within a fixed-bed ion-exchange column and then activated by contact with an acid solution to form a nanomaterial composite comprising hydrogen ions.

Thus, in another embodiment, the present disclosure also includes a process for producing a lithium salt from a liquid resource that generally includes: (i) providing a fixed bed ion-exchange column where the ion exchange column comprises a nanomaterial composite according to the present disclosure, the nanomaterial composite comprising hydrogen ions (i.e. the nanocomposite material has been contacted with an acid solution having a given acid concentration in a sufficient amount to remove the lithium ions originally present in the nanomaterial composite and replacing them with hydrogen ions), (ii) contacting the nanomaterial composite within the ion exchange column with a liquid resource to selectively extract lithium from the liquid resource, whereby hydrogen ions from the nanomaterial composite are exchanged with only lithium ions from the liquid resource to produce a lithium-enriched nanomaterial composite; (c) contacting the lithium-enriched nanomaterial composite with an acid solution, whereby lithium ions from the lithium-enriched nanomaterial composite are exchanged with hydrogen ions from the acid solution to produce a concentrated aqueous lithium salt. In particular, the lithium ions exchanged with the hydrogen ions form a water soluble salt containing the anion of the respective used acid. For example, LiCl will be recovered when the acid solution contains HCl; LiNO₃ will be recovered when the acid solution contains HNO₃; Li₂SO₄ will be recovered when the acid solution contains H₂SO₄; and, Li(CH₃COO) will be recovered when the acid solution contains CH₃COOH.

In one embodiment, the fixed bed ion-exchange column comprising a bed of nanomaterial composite having a desired size and shape is first activated by contacting the composite with an acid solution having a given acid concentration in a sufficient amount to remove the lithium ions originally present in the nanomaterial composite to produce a “protonated” form of the sized and shaped nanomaterial composite comprising hydrogen ions. This activated material is then contacted with a lithium-containing liquid resource and the lithium ions contained within the liquid resource are selectively extracted from the liquid resource while the other ions present in the liquid resource pass through the column. Depending on the activated nanomaterial composite and the lithium-containing liquid resource, conditions necessary for the extraction are generally known to those skilled in the art and include, for example the liquid resource flow rate, the operating temperature, the operating pressure and any other required parameter for selectively extracting lithium from the liquid resource. Next, the lithium-enriched nanomaterial composite is contacted with an acid solution to exchange the lithium ions with hydrogen ions to produce a concentrated aqueous salt of lithium. This concentrated aqueous solution then passes through the column and may then be further processed to obtain crystals of the lithium salt or modified to generate other types of lithium compounds in the art of secondary and known processes.

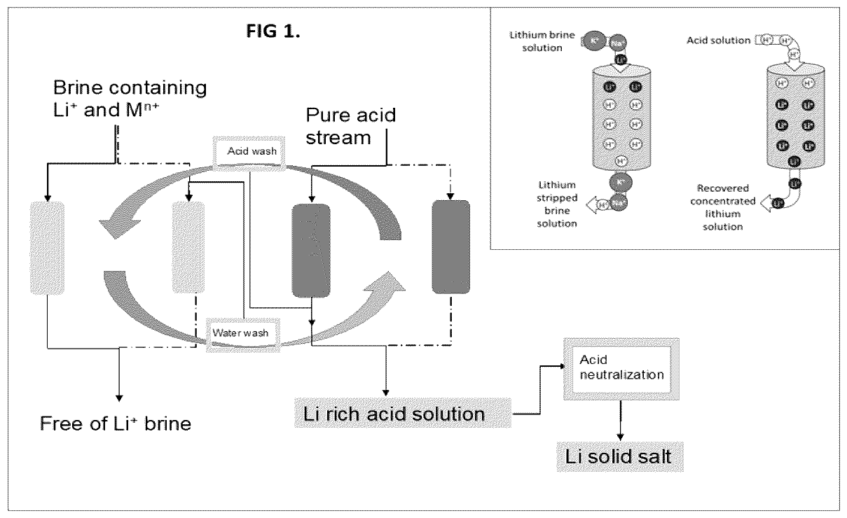

FIG. 1 generally depicts a schematic of the process that illustrates the lithium extraction/recovery by ion-exchange using the nanomaterial composites of the present disclosure. During the extraction step, the liquid resource containing the lithium ions is fed to the ion-exchange column where the nanomaterial composite (which beforehand was activated by contacting the composite with an acid solution to extract the lithium ions and incorporate hydrogen ions within its structure) and the lithium ions present in the liquid resource are selectively extracted by ion-exchange with the hydrogen ions present in the nanocomposite as shown in the left side of the inset in FIG. 1. Because of the unique properties of the nanomaterial composite, other cations present in the liquid resource are prevented from entering the channels/cavities of the nanomaterial composite and thus pass through the column without being affected. In this way, a lithium stripped liquid resource (or a liquid resource substantially free of lithium) is obtained at the exit of the column. According to embodiments, the liquid resource may be passed through the column in either an up flow or down flow manner depending on the extraction/recovery system implemented, the type of liquid resource and the nanomaterial composite used. In some embodiments, pre-treatment of the liquid resource may be necessary depending on the type and source of the liquid resource. Examples of such pretreatments include filtration, addition of various chemicals to modify the pH or precipitate unwanted materials and the like. Increasing the temperature of the liquid resource may also be required in some embodiments with an increase of a maximum temperature of about 100° C., but preferentially the temperature of the liquid resource is between room temperature and about 80° C. The flow of the liquid resource through the column may be from about 0.0001 Bed-Volume (BV) per hour up to about 100 BV per hour and pressures can be from atmospheric pressure up to about 200 psig. A water wash may optionally be passed through the column after the selective extraction of lithium ions to remove any excess liquid resource that may be on the surface of the column bed.

Next, the recovery of the lithium trapped inside the nanomaterial composite is carried out by passing an acid solution through the nanomaterial composite such that the protons (hydrogen ions) enter the channels/cavities of the nanomaterial composite and ion-exchange with the lithium ions as depicted in the right side of the inset of FIG. 1. The acid solution can be composed of HCl or HNO₃ or H₂SO₄ or CH₃COOH depending on the desired lithium salt to be recovered. The concentration of the employed acid solution can be varied depending on the final desired concentration of the salt that is selected as the targeted product. Preferentially, the temperature of the acid solution is room temperature (about 22° C. to about 25° C.) as the stripping typically occurs quickly at this temperature. The flow of the acid solution through the column may be from about 0.1 Bed-Volume (BV) per hour up to about 1000 BV/h; pressures can be from atmospheric pressure up to about 200 psig.

After the acid solution is passed through the nanomaterial composite and the lithium is recovered, a water wash may be needed to remove excess acid on the surface of the nanomaterial composite in order to prepare the column for another cycle of lithium stripping from the liquid resource. In some embodiments, several fixed bed ion-exchange columns may be working in parallel in order to make the process more efficient. For example, one column may be selectively extracting lithium from the liquid resource while another column is recovering lithium from the nanomaterial composite during contact with the acid solution, while still another column is washed with water in order to ready for the column for the next cycle.

The nanomaterial composites of the present disclosure, their preparation methods and their use for extraction and recovery of lithium from brine solutions will be better understood by reference to the following non-examples.

### EXAMPLES

The raw materials used in the preparation of the nanomaterial composites according to the present disclosure and referenced in the following examples were purchased from Sigma Aldrich and included: commercial lithium hydroxide (LiOH, ≥98%, MW 23.95), titanium dioxide (TiO₂, Nano powder, 21 nm primary particle size, ≥99.5%), zirconium oxide (ZrO₂, Nano powder, <100 nm particle size, MW 123.22), Ludox AS40 (SiO₂, MW 60.08, 40 wt. % suspension in H₂O), lithium chloride (LiCl, ≥99%, MW 42.39), potassium chloride (KCl, ≥99%, MW 74.55), magnesium chloride (MgCl₂·6H₂₂O, MW 203.30), aluminum nitrate (Al(NO3)₃·9H₂O, MW 375.13), sodium silicate solution (Na₂O: 10.6%; SiO₂: 26.5%) and aluminum hydroxide (Al(OH)₃ MW 78.00).

### Example 1. Preparation of a Lithium Titanate Nanomaterial Composite

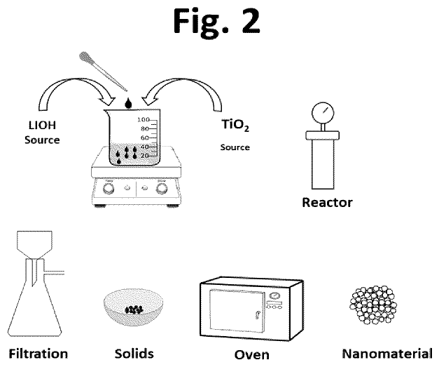

FIG. 2 depicts a generic schematic for the preparation of a nanomaterial composite lithium titanate (Li₂TiO₃) using a hydrothermal preparation method in a 300 ml Parr reactor. Reaction conditions were 120° C. for 36 hours under 300 rpm of agitation, cooling and then filtering the resulting product without washing. The reaction for producing the nanomaterial composite is:

2LiOH+TiO₂→Li₂TiO₃+H₂O

The following reaction mixture was prepared using a 2.2 atomic molar ratio of lithium to titanium:
Lithium hydroxide 6.48 g
Nano titanium oxide 9.9 g
Deionized water 180 g

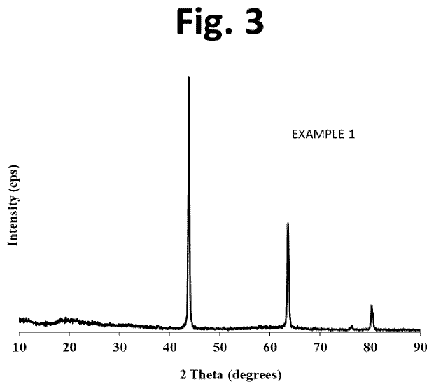

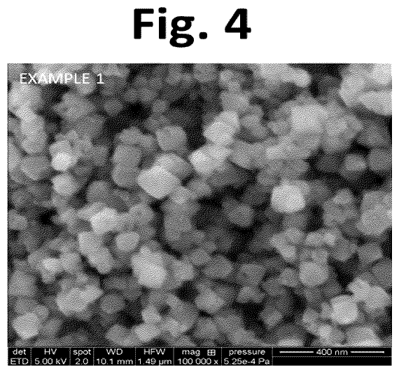

The crystallinity of the resulting nanomaterial composite was confirmed using X-ray diffraction (XRD) and found to be cubic Li₂TiO₃ as shown in FIG. 3. The average crystalline domain size was estimated using the Scherer equation as implemented in the PDXL program and revealed an average value of about 39 nm±4 nm. Textural properties of the nanomaterial were analyzed by Brunauer-Emmet-Teller (BET) and the results are shown in Table 2. FIG. 4 depicts a Scanning Electron Microscopy (SEM) image for this synthesized nanomaterial composite. The average nanoparticle size was estimated by different characterization techniques and compared in Table 1 below. The particle sizes are consistent for the two estimates obtained by XRD and SEM to be in the nanorange.

TABLE 1
Average nanoparticle size estimation using different techniques

| Employed technique | Average Nanoparticle size [nm] |
|---|---|
| XRD | 39 ± 4 |
| SEM | 46 ± 3 |

TABLE 2
BET Measurements of Li₂TiO₃

| BET measurements | Li₂TiO₃ |
|---|---|
| BET Surface Area (m²/g) | 24.8 |
| Micropore Area (m²/g) | 6.2 |
| External Surface Area (m²/g) | 18.6 |
| Pore volume (cm³/g) | 0.16 |
| Average Pore width (nm) | 33.9 |

### Example 2. Preparation of Another Phase of Lithium Titanate Nanomaterial Composite by Calcination of the Example 1 Lithium Titanate Nanomaterial at 450° C.

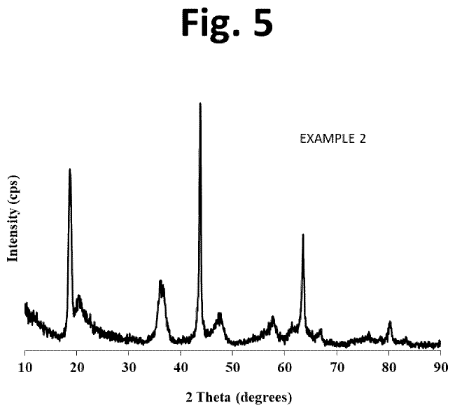

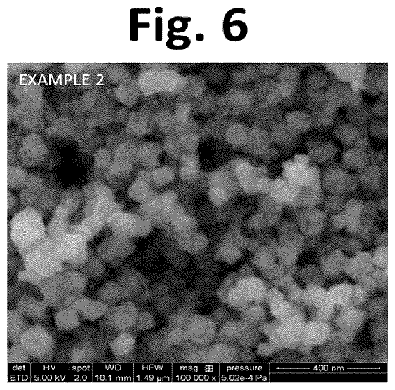

A nanomaterial was prepared in a similar fashion as the one presented in EXAMPLE 1 and the obtained dried solid was calcined in an oven at 450° C. for 6 hours. FIG. 5 depicts the XRD pattern of the calcined Li₂TiO₃ showing the formation of another cubic phase of Li₂TiO₃ that is different from the one obtained in EXAMPLE 1. As shown in FIG. 5, the pattern of the product of EXAMPLE 2 is different from that of EXAMPLE 1. FIG. 6 depicts the SEM images of the calcined Li₂TiO₃ from EXAMPLE 2. The BET measurements are presented in Table 3 below. While the crystal structure for the product in EXAMPLE 2 changed, the average crystalline domain size and morphology did not change when compared with that for EXAMPLE 1.

TABLE 3
BET Measurements for calcinated Li₂TiO₃ at 450° C.

| BET measurements | Li₂TiO₃ |
|---|---|
| BET Surface Area (m²/g) | 24.7 |
| Micropore Area (m²/g) | 0.9 |
| External Surface Area (m²/g) | 23.8 |
| Pore volume (cm³/g) | 0.36 |
| Average Pore width (nm) | 42.7 |

### Example 3. Preparation of Another Phase of Lithium Titanate Nanomaterial by Calcination of Example 1 Lithium Titanate at 650 ° C.

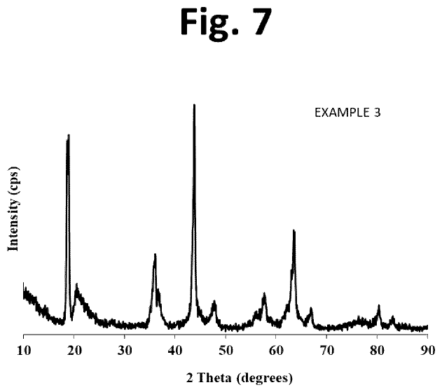

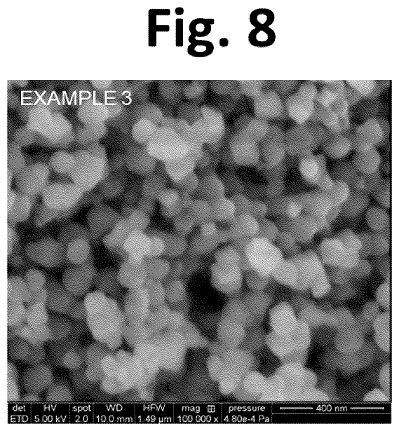

Preparation of this nanomaterial composite was similar to the one presented in EXAMPLE 1, except the product was calcined in an oven at 650° C. for 6 hours instead of 450° C. as in EXAMPLE 2. FIG. 7 depicts the XRD pattern and FIG. 8 depicts the SEM images for this calcined Li₂TiO₃. The BET measurements are presented in Table 4 below. Morphology of the crystals for this product were found to have changed slightly.

TABLE 4
BET Measurements for calcined Li₂TiO₃ at 650° C.

| BET measurements | Li₂TiO₃ |
|---|---|
| BET Surface Area (m²/g) | 20.81 |
| Micropore Area (m²/g) | 1.1 |
| External Surface Area (m²/g) | 19.74 |
| Pore volume (cm³/g) | 0.29 |
| Average Pore width (nm) | 43.7 |

### Example 4. Preparation of a Lithium Silicate Nanomaterial Composite

The preparation procedure of a nanomaterial composite lithium silicate (Li₂SiO₃) was performed that was similar to the hydrothermal preparation method used in EXAMPLE 1. Reaction conditions were 80° C. for 72 hours under 300 rpm agitation with no washing of the obtained product. The reaction for producing this nanomaterial composite is:

2LiOH+SiO₂→Li₂SiO₃+H₂O

The following reaction mixture was prepared using a 2.2 atomic molar ratio of lithium to silicon:
Lithium hydroxide 7.8 g
Ludox AS40 22.5 g
Deionized water 180 g

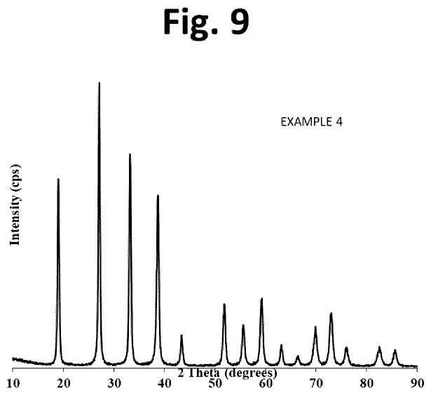

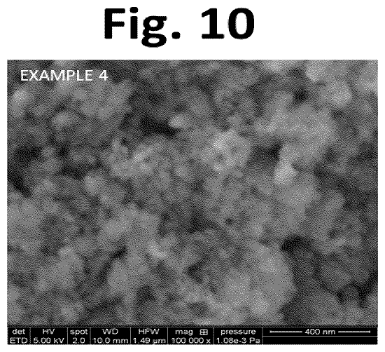

The obtained crystalline material was analyzed using X-ray diffraction (XRD). The pattern depicted in FIG. 9 indicated the formation of Li₂SiO₃. The obtained crystalline material was analyzed by the Brunauer-Emmet-Teller (BET) method and measurements for Li₂SiO₃ are shown in Table 5 below. FIG. 10 depicts the Scanning Electron Microscopy (SEM) images for the crystalline material.

TABLE 5
BET Measurements of Li₂SiO₃

| BET measurements | Li₂SiO₃ |
|---|---|
| BET Surface Area (m²/g) | 31.6 |
| Micropore Area (m²/g) | 5.8 |
| External Surface Area (m²/g) | 25.8 |
| Pore volume (cm³/g) | 0.26 |
| Average Pore width (nm) | 25.6 |

### Example 5. Preparation of Another Phase of Lithium Titanate Nanomaterial Composite by Calcination of the Example 4 Lithium Silicate Nanomaterial at 750° C.

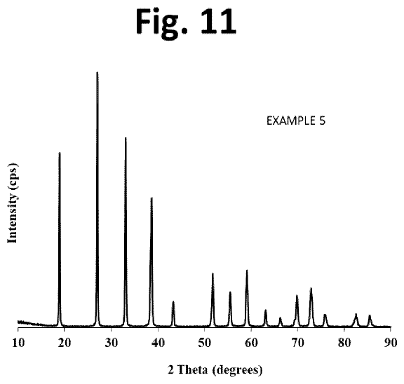

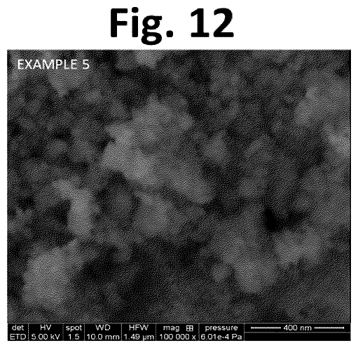

Preparation of this nanomaterial was similar to the one presented in EXAMPLE 4, except that after hydrothermal crystallization, the dried solid was calcined in an oven at 750° C. for 6 hours. FIG. 11 shows the XRD spectrum of the calcined Li₂SiO₃ which has the same crystal structure, but with different crystalline domains (the signals are less broader than those found for EXAMPLE 4). The BET measurements are presented below in Table 6. FIG. 12 depicts the SEM images of the calcined Li₂SiO₃.

TABLE 5
BET Measurements for calcined Li₂SiO₃ at 750° C.

| BET measurements | Li₂SiO₃ |
|---|---|
| BET Surface Area (m²/g) | 30.7 |
| Micropore Area (m²/g) | 7.2 |
| External Surface Area (m²/g) | 24.1 |
| Pore volume (cm³/g) | 0.20 |
| Average Pore width (nm) | 22.1 |

### Example 6. Preparation of a Lithium Zirconate Nanomaterial Composite

The preparation of a nanomaterial composite, lithium zirconate (Li₂ZrO₃), was carried out using a solid state reaction in an oven. Reaction conditions were 650° C. for 6 hours with no washing. The reaction for this nanomaterial composite is:

2LiOH+ZrO₂→Li₂ZrO₃+H₂O

The following reaction mixture was prepared using a 2.0 molar ratio of lithium to zirconium and enough water in order to make a paste:
Lithium hydroxide 2.31 g
Zirconium oxide 6 g
Deionized water 10 g

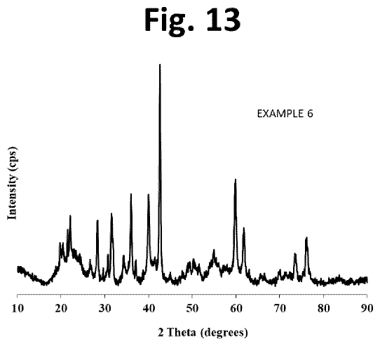

The resulting nanomaterial was analyzed by using X-ray diffraction (XRD) and the obtained pattern is shown in FIG. 13.

### Example 7. Preparation of an Aluminum-Doped Lithium Silicate Nanomaterial Composite with the Structure of the Lithium Silicate of Example 4

The preparation procedure of an aluminum-doped nano lithium silicate (Al-doped Li₂SiO₃) using a hydrothermal preparation method in a 300 ml Parr was performed. Reaction conditions were 180° C. for 60 hours under 300 rpm agitation. After the reaction was finished and the mixture was cooled, the obtained solid was filtered, washed with water and dried to obtain the Al-doped lithium silicate according to the present disclosure.

The following reaction mixture was prepared using a 4.8 molar ratio of lithium to silicon and a 2.0 molar ration of silicon to aluminum:
Lithium hydroxide 17.244 g
Ludox AS40 22.5 g
Aluminum hydroxide 5.842 g
Deionized water 180 g

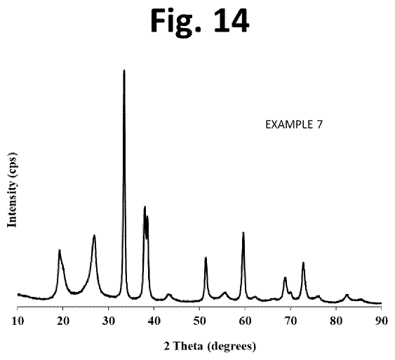

The obtained crystalline material was analyzed using X-ray diffraction (XRD) and the pattern is depicted in FIG. 14 confirming the formation of Al-doped Li₂SiO₃. The material was analyzed by the Brunauer-Emmet-Teller (BET) method and measurements for the Al-doped Li₂SiO₃ are shown below in Table 6.

TABLE 6
BET Measurements of Al-doped Li₂SiO₃

| BET measurements | Al-doped Li₂SiO₃ |
|---|---|
| BET Surface Area (m²/g) | 59.5 |
| Micropore Area (m²/g) | 7.5 |
| External Surface Area (m²/g) | 52.0 |
| Pore volume (cm³/g) | 0.314 |
| Average Pore width (nm) | 17.4 |

### Example 8. Preparation of a Lithium Aluminosilicates Nanomaterial Composite

This example demonstrated a way of preparing a lithium aluminosilicate with the β-Spodumene (β-LiAlSi₂O₆) structure. The preparation used a combined precipitation and thermal treatment. For precipitation, the following reactants were employed:
Sodium silicate solution 34.523 g
Aluminum nitrate 28.914 g
Sodium hydroxide 15.062 g
Deionized water (1) 100 g
Concentrated sulfuric acid 12.541 g
Lithium hydroxide 1.803 g
Deionized water (2) 15 g

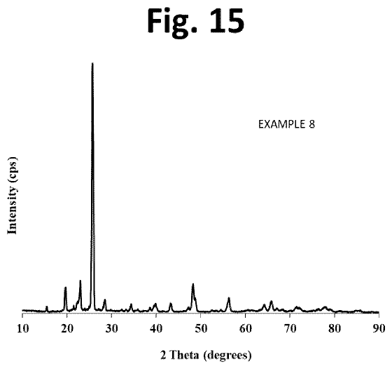

An acid solution of sulfuric acid was prepared from the deionized water (1) and the concentrated sulfuric acid. The aluminum nitrate and the sodium silicate were then dissolved in the acid solution. To produce the precipitation of the aluminosilicate, the sodium hydroxide was added in small increments until a precipitate gel was formed with a pH of about 8. The precipitate was filtered and washed with deionized water until no sulfate was detected. After the wet cake was no longer showing the presence of sulfate, it was placed in a beaker and mixed with a solution of lithium hydroxide dissolved in deionized water (2). After homogenization of this solution, the beaker was placed in an oven at 80° C. until the mixture was completely dried. The amorphous material was placed in a crucible and then placed in an oven and calcined at 850° C. for 2 hours. After cooling, the obtained crystalline material was analyzed using X-ray diffraction (XRD). The pattern is depicted in FIG. 15 indicating the formation of β-LiAlSi₂O₆. The material was also analyzed by the Brunauer-Emmet-Teller (BET) method and measurements for β-LiAlSi₂O₆ are shown in Table 7.

TABLE 7
BET Measurements of β-LiAlSi₂O₆

| BET measurements | β-LiAlSi₂O₆ |
|---|---|
| BET Surface Area (m²/g) | 0.79 |
| Micropore Area (m²/g) | 0.16 |
| External Surface Area (m²/g) | 0.63 |
| Pore volume (cm³/g) | 0.032 |
| Average Pore width (nm) | 61.2 |

### Example 9. Activation and Recovery

In this example, a solution of 1.2 M nitric acid was used to activate the solids produced in EXAMPLES 1 and 2. For each test, about 1 gram of EXAMPLE 1 or 2 solid (containing about 126.5 mg of Li per gram of Li₂TiO₃) was exposed to 15 mL of the acid solution for a given period of time (from 1 minute to 1440 minutes) at room temperature. The mixture was filtered and the recovered solution tested to determine the extracted amount of lithium from the activated solids via ICP. The ion exchange of lithium ions by protons ions was confirmed by ICP and the results are presented in Table 8 where it can be seen that very short periods of time were required to retrieve up to 95% of the expected lithium from the tested nanomaterial composites of the present disclosure; and thus, their activation was carried out in this way.

TABLE 8
Activation of the nanomaterials
composites of EXAMPLES 1 and 2

| | Extracted mg of Li per | Extracted mg of Li per |
|---|---|---|
| Contact Time | gram of Li₂TiO₃ of | gram of Li₂TiO₃ of |
| (minutes) | EXAMPLE 1 | EXAMPLE 2 |
| 1 | 92.0 | 93.8 |
| 15 | 93.0 | 95.3 |
| 30 | 94.1 | 102.5 |
| 60 | 120.0 | 100.3 |
| 1440 | 115.1 | 93.9 |

### Example 10 Activation and Recovery

In this example, 0.5 grams of each of the nanomaterial composites from EXAMPLE 3 and EXAMPLE 8 were mixed with 0.456 g and 0.134 g of 98% concentrated sulfuric acid, respectively. The mixtures were placed in an oven for a thermal treatment of 250° C. for 30 minutes. After cooling, the solids were dispersed in deionized water to recover the lithium as a solution of lithium sulfate. The solids were then filtered and dried and thus activated. The solutions were recovered by filtration having a known concentration of lithium sulfate tested by ICP. The ion exchange of lithium ions by protons ions was confirmed by ICP and the results are presented in Table 9 where it can be seen that, depending on the employed material, up to 90% of the expected lithium from the tested nanomaterial composites of the present disclosure can be recovered.

TABLE 9
Activation of the nanomaterials
composites of EXAMPLES 3 and 8

| | Theoretically | Experimental |
|---|---|---|
| Nanomaterial Composite | expected value | obtained value |
| Extracted mg of Li per gram of Li₂TiO₃ | 126.5 | 115.1 |
| from EXAMPLE 3 | | |
| Extracted mg of Li per gram of β- | 37.3 | 24.2 |
| LiAlSi₂O₆ from EXAMPLE 8 | | |

### Example 11. Preparation of a Larger Batch of Lithium Titanate Nanomaterial Composite

This example demonstrated the preparation of a nanomaterial composite lithium titanate (Li₂TiO₃) similar to the one in EXAMPLE 1, but in this case using a 1-gallon Parr reactor to produce enough material for testing the extraction of lithium from liquid resources. Reaction conditions were 120° C. for 36 hours under 150 rpm of agitation, cooling and then filtering the resulting product without washing.

The following reaction mixture was prepared using a 2.2 molar ratio of lithium to titanium:
Lithium hydroxide 81.65 g
Nano titanium oxide 124.74 g
Deionized water 2,268 g

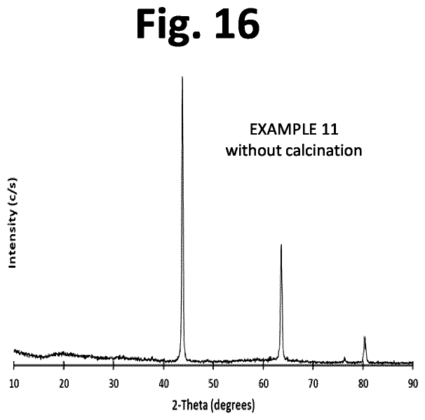

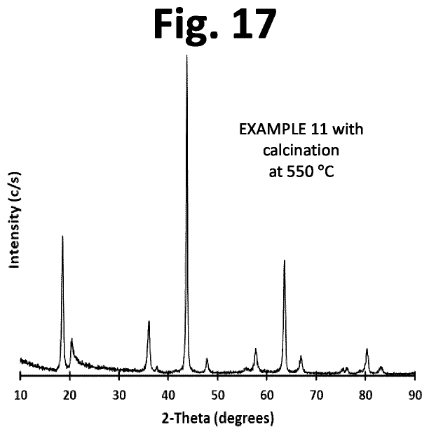

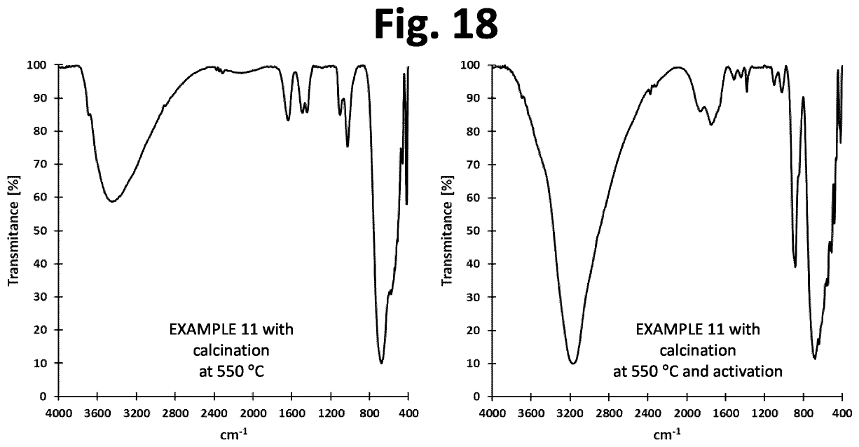

The crystallinity of the resulting nanomaterial composite was confirmed using X-ray diffraction (XRD) and found to be cubic Li₂TiO₃ as shown in FIG. 16. The average crystalline domain size was estimated using the Scherer equation as implemented in the PDXL program and revealed an average value of about 37 nm±5 nm. A portion of the material was calcined at 550° C. for 6 hours and the XRD data shown in FIG. 17 confirmed the transformation of the original structure. Textural properties of the nanomaterial were analyzed by Brunauer-Emmet-Teller (BET) and the results are shown in Table 10 and compared to the nanomaterial not calcined. A small portion of the calcined material was activated in a similar fashion as described in EXAMPLE 9 and the infrared spectra of the calcined sample before and after activation, and as shown in FIG. 18, it is very clear the appearance of two strong signals at around 3200 cm⁻¹ and 885 cm⁻¹ after the activation process indicated the successful modification of the internal structure of the nanomaterial by replacement of the lithium ions with proton ions making the nanomaterial ready for lithium uptake from liquid resources.

TABLE 10
BET Measurements of Li₂TiO₃ as prepared and calcined at 550° C.

| | | Li₂TiO₃ |
|---|---|---|
| BET measurements | Li₂TiO₃ | 550° C. |
| BET Surface Area (m²/g) | 23.1 | 21.0 |
| Micropore Area (m²/g) | 2.0 | 1.2 |
| External Surface Area (m²/g) | 21.1 | 19.8 |
| Pore volume (cm³/g) | 0.15 | 0.27 |
| Average Pore width (nm) | 24.7 | 37.2 |

### Example 12. Preparation of a Composite Extruded Material of Lithium Titanate Nonmaterial for Its Application as a Lithium Removal Sorbent from Liquid Resources

This example demonstrated the preparation of a composite lithium titanate (Li₂TiO₃) nanomaterial with silica to produce a shaped solid for its use in a column bed for lithium extraction from liquid resources. 166.6 grams of the non-calcined material of EXAMPLE 11 were mixed with a solution prepared by diluting 61.2 grams of sodium silicate with 46.7 mL of deionized water. The formed paste was extruded into spaghetti-like shapes using an in-house built mechanical stainless steel extruder. The extruded material was allowed to dry at room temperature overnight. The extrudates were cut into sizes of about 1 cm length (or lower) and then placed inside a stainless steel tray and dried at 100° C. for six hours and then calcined at 550° C. for six hours with a heating ramp of 5° C./min. 162.1 g of silica-nanocomposite adsorbent was recovered and placed inside a sealed plastic container for further use.

### Example 13. Use of a Silica-Nanocomposite Extruded Material for Lithium Removal from a Liquid Resource

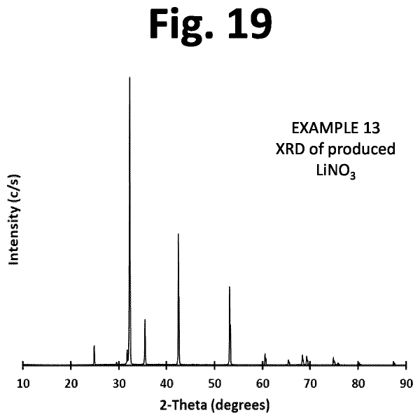

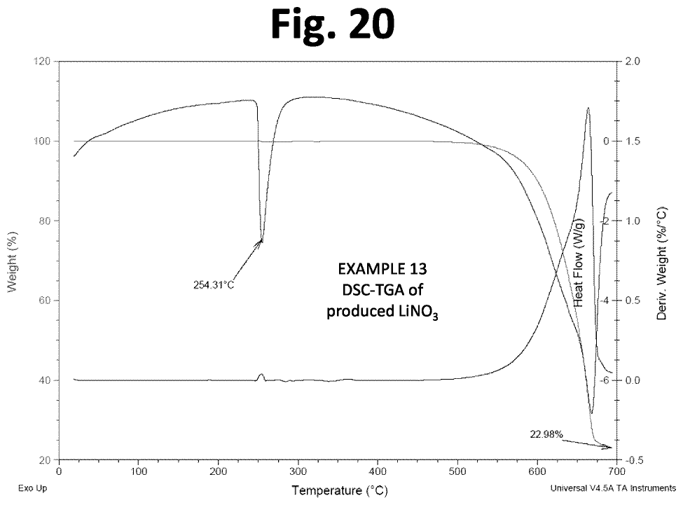

This example demonstrated the use of a composite lithium titanate (Li₂TiO₃) nanomaterial with silica in a column bed for lithium extraction from a liquid resource. 150 grams of the extruded composite material of EXAMPLE 12 was packed in a column having a diameter of 1¼ inches and a height of 13 inches. The nanomaterial in the column was activated with a solution of nitric acid 1 M, such as shown in FIG. 1, with a flow of 2.3 L/min at room temperature in a recirculating manner for 2 hours. After activation, the liquid was removed, and the column was washed with deionized water. A brine with a composition of 1200 ppm of Li, 1000 ppm of Ca, 1000 ppm of K and 1000 ppm of Mg was then flowed through the column at a flow rate of 2.3 L/min at room temperature in a recirculating manner for 6 hours. After this time, the brine was removed from the system and deionized water was used to clean the column. After cleaning with water, a solution of 0.36 M nitric acid was employed to recover the lithium from the sorbent at a flow rate of 2.3 L/min at room temperature for 2 hours in a recirculating manner. The recovered lithium-rich solution was placed in a rotary evaporator where water was removed and the salt was crystallized. The recovered solid was placed in an oven at 120° C. overnight for further drying and 23 grams of lithium nitrate salt was recovered. FIG. 19 and FIG. 20 show, respectively, the XRD pattern and the DSC-TGA of the recovered LiNO₃ salt (having a melting point of about 254.3° C. and a temperature of decomposition beyond 600° C.).

While the foregoing is directed to various embodiment s of the present disclosure, other and further embodiments of the disclosure may be devised without departing from the basic scope thereof, and the scope thereof is determined by the claims that follow.

What is claimed is:

1. A nanomaterial composite obtained by mixing in an aqueous medium at least one lithium source and at least one other source selected from a silicon source, an aluminum source, a titanium source, a zirconium source, a metal-phosphate source and a mixture thereof to form a suspension at an atomic molar ratio of lithium to the other source of at least 2.0:1; subjecting the suspension to a hydrothermal treatment to form the nanomaterial composite; and optionally subjecting the nanomaterial composite to a thermal treatment wherein the nanomaterial composite has a domain size of less than 100 nm.

2. The nanomaterial composite of claim 1, wherein the hydrothermal treatment comprises subjecting the suspension to a temperature of between about 60° C. to about 250° C. to for a period of time of between about 1 hour to about 84 hours.

3. The nanomaterial composite of claim 1, wherein the lithium source is lithium chloride, lithium hydroxide, lithium nitrate, lithium sulfate, lithium carbonate or a mixture thereof.

4. The nanomaterial composite of claim 1, wherein the other source is titanium dioxide, zirconium oxide, silicon dioxide, aluminum nitrate, sodium silicate, aluminum hydroxide, sodium silicate, iron phosphate, zinc phosphate, zinc phosphate, manganese phosphate or magnesium phosphate.

5. The nanomaterial composite of claim 4, wherein the other source is first treated with an acid or base in order to produce a homogeneous precipitate or a smooth gel, either of which can be washed and dried.

6. The nanomaterial composite of claim 5, wherein the acid is selected from nitric acid, hydrochloric acid, sulfuric acid and carboxylic acid.

7. The nanomaterial composite of claim 5, wherein the base is selected from lithium hydroxide, sodium hydroxide, potassium hydroxide and ammonia.

8. The nanomaterial composite of claim 1, wherein the nanomaterial composite has a domain size of between about 10 nm and about 90 nm.

9. The nanomaterial composite of claim 1, wherein the nanomaterial composite is subjected to a thermal treatment at a temperature of between about 100° C. and about 1050° C. for a period of time of between about 1 hour to about 84 hours.

10. The nanomaterial composite of claim 1, wherein the nanocomposite material is composited with an inorganic or organic binder or agglomerate.

11. A process for producing a lithium salt from a liquid resource comprising: (i) placing a nanomaterial composite according to claim 1 within a column and then activating the nanomaterial composite by contacting the nanomaterial composite with a first acid solution to exchange the lithium ions within the composite with hydrogen ions; (ii) passing the liquid resource through the column to selectively extract lithium from the liquid resource to form a lithium-enriched nanomaterial composite; and (iii) contacting the lithium-enriched nanomaterial composite with a second acid solution to produce the lithium salt.

12. The process of claim 11, further comprising recovering the lithium salt.

13. A lithium salt recovered according to the process of claim 12.

14. A process for producing a lithium salt from a liquid resource comprising: (i) providing a fixed bed ion-exchange column wherein the ion exchange column comprises a nanomaterial composite according to claim 1, (ii) contacting the nanomaterial composite with an acid to thereby replace lithium ions with hydrogen ions, (ii) contacting the nanomaterial composite in the ion-exchange column with a liquid resource to selectively extract lithium from the liquid resource, wherein the hydrogen ions from the nanomaterial composite are exchanged with only lithium ions from the liquid resource to produce a lithium-enriched nanomaterial composite; (iii) contacting the lithium-enriched nanomaterial composite with an acid solution, wherein lithium ions from the lithium-enriched nanomaterial composite are exchanged with hydrogen ions from the acid solution to produce the lithium salt.

15. A nanomaterial composite obtained by mixing in an aqueous medium at least one lithium source and a colloidal silica solution to form a suspension at an atomic molar ratio of lithium to silica of at least 2.0:1; and, subjecting the suspension to a hydrothermal treatment to form the nanomaterial composite.

16. The nanomaterial composite of claim 15, wherein the hydrothermal treatment comprises subjecting the suspension to a temperature of about 60° C. to about 250° C. and for a period of time from about 1 hour to about 84 hours.

17. The nanomaterial composite of claim 16, wherein the nanomaterial composite is further subjected to a thermal treatment at a temperature of from about 100° C. to about 1050° C. and for a period of time from about 1 hour to about 84 hours.

18. The nanomaterial composite of claim 15, wherein an aluminum salt is mixed with the lithium source and the colloidal silica solution to form the suspension.

19. The nanomaterial composite of claim 18, wherein the aluminum salt comprises Al(NO₃)₃ or Al(OH)₃.

20. The nanomaterial composite of claim 19, wherein the lithium source comprises lithium hydroxide.

21. The nanomaterial composite of claim 20, wherein the nanomaterial composite comprises a lithium Al-doped silicate nanomaterial composite.

22. A nanomaterial composite obtained by mixing in an aqueous medium at least one lithium source and a metal-phosphate source to form a suspension at an atomic molar ratio of lithium to the metal of the metal-phosphate source of at least 2.0:1; and, subjecting the suspension to a hydrothermal treatment to produce the nanomaterial composite wherein the metal of the metal-phosphate source is selected from Fe²⁺, Zn²⁺, Co²⁺, Cu²⁺, Mn²⁺, Ni³⁺ and a mixture thereof.

23. The nanomaterial composite of claim 22, wherein the suspension is placed inside a reactor and hydrothermally treated at a temperature of about 65° C. to about 200° C. and for a period of time from about 1 hour to about 84 hours to produce a lithium metal-phosphate nanomaterial composite and further subjecting the lithium metal-phosphate nanocomposite to a thermal treatment at a temperature of from about 100° C. up to about 1050° C. and for a period of time from about 1 hour to about 84 hours.
